(19) United States
(12) Patent Application Publication
(10) Pub. No.: US 2005/0228758 A1
(43) Pub. Date: Oct. 13, 2005

(54) Telephone call fee payment certificate number sales system and device

(76) Inventors: Michihiro Ota, Saitama (JP); Hiroaki Yoshida, Saitama (JP); Hiroaki Shinada, Saitama (JP); Hiroki Hoshino, Saitama (JP); Kumiko Hisai, Saitama (JP); Akira Onodera, Saitama (JP)

Correspondence Address: WELSH & KATZ, LTD, 120 S RIVERSIDE PLAZA, 22ND FLOOR, CHICAGO, IL, 60606, US

(21) Appl. No.: 10/514,350

(22) PCT Filed: May 13, 2003
(86) PCT No.: PCT/JP03/05917

§ 371 Date: Nov. 12, 2004

(30) Foreign Application Priority Data
May 16, 2002 (JP) 2002-141655

(51) Int. Cl. G06F 17/00

(52) U.S. Cl. 705/400

(57) ABSTRACT

A mobile telephone call fee pre-payment registration system and device capable of registering telephone call permission without requiring a complicated input operation causing erroneous input. A telephone call fee pre-payment registration device (20) performs money deposit processing for recognizing amount information (money deposit information) relating to money introduced into a money deposit processing section by a user, and performs control for obtaining identification information from the mobile telephone terminal (10) via a first communications unit (23), and sending the identification information thus obtained and the money deposit information processed by the money deposit processing unit, to a registration center device (40) via a second communications unit (24).

### TECHNICAL FIELD

The present invention relates to a telephone call fee payment certificate number sales system and device for selling telephone call fee payment certificate numbers certifying that a telephone call fee for a pre-paid system mobile telephone terminal has been paid, and more particularly, to a system and a device for selling telephone call fee payment certificate numbers to mobile telephone terminals via communications means, by receiving payment of a pre-paid telephone call fee from a user carrying a mobile telephone terminal.

### BACKGROUND ART

In order to prevent failure to pay telephone call fees by a foreign traveler residing in the country for a short period of time, or in order to popularize use amongst children who do not have payment capacity, mobile telephones for exclusive use with telephone call fee pre-payment systems have been developed by respective mobile telephone manufacturers.

Conventional pre-payment systems designed for mobile telephones of this kind for exclusive use with telephone call fee pre-payment systems require the actions of purchasing a card bearing a unique number which is concealed by a scratchable covering, or the like, confirming the unique number printed on the card by removing the scratchable covering, or the like, and then registering that unique number with a charging center.

Consequently, if the user of a mobile telephone for exclusive use with a telephone call fee pre-payment system seeks to register the telephone with the charging center, in order to be able to make a telephone call using the mobile telephone, he or she is required to perform complicated registration operations, such as manually inputting a large number of digits corresponding to the unique number, and hence human input errors are liable to occur.

In this way, in a conventional pre-payment system designed for mobiles telephones for exclusive use with telephone call fee pre-payment systems, pre-payment of the telephone call fee is made by purchasing a card corresponding to a prescribed telephone call fee, from a card selling device. Thereupon, in order to be able to make a call using the mobile telephone, it is necessary for the user to register the unique number printed on the purchased card with the charging center, by inputting the number manually, and hence there is a problem in that the registration operation is extremely complicated and input errors are liable to occur.

### DISCLOSURE OF THE INVENTION

Therefore, it is an object of the present invention to resolve the aforementioned problem by provide a telephone call fee payment certificate number sales system and device whereby complicated input operations are not required, and input errors can be eliminated, when registering a unique number issued after a telephone call fee has been paid, with a charging center.

In order to achieve the aforementioned objects, the invention according to claim 1 is a telephone call fee payment certificate number sales system comprising: a pre-paid system mobile telephone terminal; and a sales device for selling a telephone call fee payment certificate number certifying that a telephone call fee has been paid, by accepting deposit of money sufficient to cover a telephone call fee to be pre-paid from a user carrying the mobile telephone terminal; wherein the mobile telephone terminal comprises: communications means for communicating with the sales device; and control means for receiving a telephone call fee payment certificate number sent by the sales device via the communications means; and the sales device comprises: money deposit processing means for processing the depositing of money for a telephone call fee that is to be pre-paid; communications means for communicating with the mobile telephone terminal; and control means for sending the telephone call fee payment certificate number to the mobile telephone terminal via the communications means, when the money deposit processing has been carried out by the money deposit processing means.

The invention according to claim 2 is the invention according to claim 1, wherein the sales device comprises: storage means for storing a plurality of telephone call fee payment certificate numbers; and the control means successively reads out the telephone call fee payment certificate numbers from the storage means and sends same to the mobile telephone terminal, when the money deposit processing has been carried out.

The invention according to claim 3 is the invention according to claim 1, wherein the sales device comprises: means for communicating with a charging center issuing telephone call fee payment certificate numbers; and the control means acquires the telephone call fee payment certificate numbers issued by the charging center, via the charging center communications means, and sends same to the mobile telephone terminal.

The invention according to claim 4 is the invention according to claim 1, wherein the communications means of the mobile telephone terminal and the communications means of the sales device are infrared communications means performing communications by means of infrared.

The invention according to claim 5 is the invention according to claim 1, wherein the communications means of the mobile telephone terminal and the communications means of the sales device are short-distance wireless communications means performing communications based on a short-distance wireless communications system.

The invention according to claim 6 is the invention according to claim 1, wherein the communications means of the mobile telephone terminal and the communications means of the sales device are wired communications means performing communications based on a wired communications system.

The invention according to claim 7 is a telephone call fee payment certificate number sales device for accepting deposit of money sufficient to cover a telephone call fee to be pre-paid from a user carrying a pre-paid system mobile telephone terminal and for selling a telephone call fee payment certificate number certifying that a telephone call fee has been paid; comprising: money deposit processing means for processing the depositing of money for a telephone call fee that is to be pre-paid; communications means for communicating with the mobile telephone terminal; and control means for sending the telephone call fee payment certificate number to the mobile telephone terminal via the communications means, when the money deposit processing has been carried out by the money deposit processing means.

The invention according to claim 8 is the invention according to claim 7, comprising: storage means for storing a plurality of telephone call fee payment certificate numbers; wherein the control means successively reads out the telephone call fee payment certificate numbers from the storage means and sends same to the mobile telephone terminal, when the money deposit processing has been carried out.

The invention according to claim 9 is the invention according to claim 7, further comprising: means for communicating with a charging center issuing telephone call fee payment certificate numbers; wherein the control means acquires the telephone call fee payment certificate numbers issued by the charging center, via the charging center communications means, and sends same to the mobile telephone terminal.

The invention according to claim 10 is the invention according to claim 7, wherein the communications means is infrared communications means for performing communications by means of infrared.

The invention according to claim 11 is the invention according to claim 7, wherein the communications means is short-distance wireless communications means for performing communications based on a short-distance wireless communications system.

The invention according to claim 12 is the invention according to claim 7, wherein the communications means is wired communications means for performing communications based on a wired communications system.

According to the present invention, the sales device sends a telephone call fee payment certificate number certifying that payment of a telephone call fee has been completed, to the mobile telephone terminal of the user, when it has accepted a process of depositing money for a telephone call fee as performed by a user of a mobile telephone terminal based on a telephone call fee pre-payment, and hence the user of the mobile telephone terminal is able to register the number with a charging center by using a stored information communicating function of the mobile telephone terminal where the telephone call fee payment certificate number sent by the sales device is stored. Consequently, the user does not have to input manually a unique number certifying that a telephone call fee has been paid, as in the prior art, and hence complicated registration operations can be eliminated and human errors can be avoided.

### BRIEF DESCRIPTION OF THE DRAWINGS

FIG. 1 is a diagram showing the composition of a telephone call fee payment certificate number sales system relating to a first embodiment;

FIG. 2 is a diagram showing the sequence of a telephone call fee payment certificate number sales process in the system according to the first embodiment,

FIG. 3 is a diagram showing the composition of a telephone call fee payment certificate number sales system relating to a second embodiment; and

FIG. 4 is a diagram showing the sequence of a telephone call fee payment certificate number sales process in the system according to the second embodiment.

### BEST MODE FOR CARRYING OUT THE INVENTION

Below, embodiments of the present invention are described in detail with reference to the accompanying drawings.

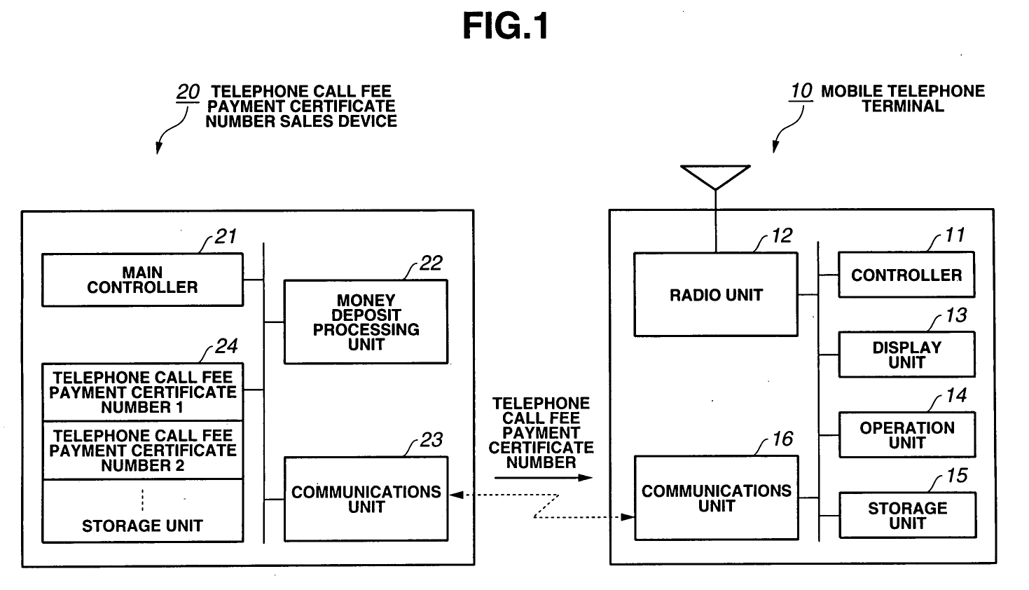

FIG. 1 is a diagram showing the general composition of a telephone call fee payment certificate number sales system relating to a first embodiment of the present invention.

In FIG. 1, the telephone call fee payment certificate number sales system is constituted by a telephone call fee pre-payment type mobile telephone terminal 10 which is carried by a user, and a telephone call fee payment certificate number sales device (hereinafter, abbreviated to “sales device”) 20, which sells telephone call fee payment certificate numbers (unique numbers) that certify payment of a telephone call fee, when money for a telephone call fee has been received from the user carrying the mobile telephone terminal 10.

In this system, the mobile telephone terminal 10 is a pre-paid system telephone terminal, wherein a telephone call fee is pre-paid, and calls can be made for the time period corresponding to the pre-paid telephone call fee.

In order to use a telephone call fee pre-payment type mobile telephone terminal 10 of this kind to make a call for a time period corresponding to the pre-paid telephone call fee, it is necessary not only to pre-pay the telephone call fee, but also to register a unique number certifying that the telephone call fee has been pre-paid, with a charging center.

When using a telephone call fee pre-payment type mobile telephone terminal 10 of this kind, conventionally, it is necessary to carry out the actions of purchasing a card of a price corresponding to the telephone call fee and then registering the unique number printed on the card, with the charging center, by entering the number manually.

On the other hand, according to the present invention, the sales device 20 sells a telephone call fee payment certificate number for certifying that a telephone call fee has been paid, by means of a communications device, rather than by means of a card as described above.

More specifically, in the system according to the first embodiment, when the user carrying the mobile telephone terminal 10 has completed the process of depositing money for the telephone call fee, the sales device 20 sends a telephone call fee payment certificate number (unique number) certifying that the payment of the telephone call fee has been completed, to the mobile telephone terminal 10 carried by that user, via a communications device.

More particularly, in the sales device 20 according to the first embodiment, storage means for storing a plurality of telephone call fee payment certificate numbers are provided, and telephone call fee payment certificate numbers are read out sequentially from the storage means and sent to the mobile telephone terminal 10, each time the aforementioned money depositing process is completed.

To describe the composition of the system relating to the first embodiment in more detail, with reference to FIG. 1, the mobile telephone terminal 10 comprises a controller 11, a radio unit 12, a display unit 13, an operating unit 14, and a storage unit 15 (each of these units having the same functions and composition as a general mobile telephone terminal), and in addition to these, it also comprises a communications unit 16 for communicating with the communications unit 23 of the sales device 20.

The communications unit 16 has a communications control function for receiving a telephone call fee payment certificate number sent by the sales device 20.

The controller 11 performs control for receiving a telephone call fee payment certificate number sent by the communications unit 23 of the sales device 20, at the communications unit 16, and storing the number in the storage unit 15.

A mobile telephone terminal 10 having this composition may naturally be used as a mobile radio telephone terminal, such as a car telephone, but it is not limited to this and may also be used as a PHS.

On the other hand, the sales device 20 comprises a main controller 21, a money deposit processing unit 22, a communications unit 23, and a storage unit 24.

The money deposit processing unit 22 is a functional part for receiving the deposit of money for a pre-paid telephone call fee, and it is constituted, for example, by a coin processing device for handling coins, or a banknote processing device for handling banknotes, or the like. Apart from this, the money deposit processing unit 22 may also be composed so as to receive the deposit of money for a pre-paid telephone call fee, by receiving a pre-paid type card, a credit card, a J.C. coin, or the like.

The money deposit processing unit 22 comprises currency input slots for inputting coins or banknotes, a card input slot for inputting pre-paid type cards, and the like, and an output opening for outputting change, and it also includes an operating unit, such as a price button, for selecting the price of the pre-paid telephone call fee that can be processed (purchased) via the device, and a display unit for displaying various information, such as operation and registration advice relating to the telephone call fee pre-payment system.

The communications unit 23 is a functional part for communicating with the communications unit 16 of the mobile telephone terminal 10 carried by the user, and more particularly, in the sales device 20, it has a communications control function for sending a telephone call fee payment certificate number issued when the user has completed the process of depositing money, to the communications unit 16 of the mobile telephone terminal 10.

In specific examples, the communications unit 23 can be realized, for example, by wired communications means performing wired communications by providing a cable and connector (the connection terminal of the mobile telephone terminal 10 being connectable to this connector terminal), by short-distance wireless communications means performing short-distance wireless communications based on Bluetooth® standards and non-contact type IC card communications standards, by infrared communications means performing communications by means of infrared, or by a combination of a plurality of these communications means.

The communications unit 16 of the mobile telephone terminal 10 which communicates with the communications unit 23 also has a communications interface similar to that of the communications unit 23.

The storage unit 24 comprises, for example, storage means for storing a plurality of telephone call fee payment certificate numbers created previously by the telecommunications operator providing the mobile telephone service based on pre-paid telephone call fees. Whenever a telephone call fee payment certificate number is purchased, it is erased from the storage unit 24. By mean of this processing, when the telephone call fee payment certificate numbers in the storage unit 24 have run out (or they have reached a prescribed number or below), then the telecommunications operator can create new telephone call fee payment certificate numbers, and replenish the storage unit 24 with these numbers, by means of an external device, such as a maintenance terminal, or the like.

The main controller 21 controls the various parts, such as the money deposit processing unit 22, the communications unit 23 and the storage unit 24, and performs control relating to the sale of telephone call fee payment certificate numbers.

More specifically, for example, if the user deposits money into the money deposit processing unit 22, by means of currency, a pre-paid card, or the like, and then presses a price button corresponding to a desired pre-paid telephone call fee, then money deposit processing is conducted for recognizing that pre-payment has been made for a telephone call fee corresponding to the total of money deposited at that time, and furthermore, control is performed for reading out a telephone call fee payment certificate number certifying that the telephone call fee corresponding to the aforementioned price has been paid, from the storage unit 24, and sending that telephone call fee payment certificate number to the mobile telephone terminal 10, by means of the communications unit 23.

On the other hand, in the mobile telephone terminal 10 carried by the user, under the control of the controller 11, operations are performed whereby the telephone call fee payment certificate number sent from the communications unit 23 of the sales device 20 is received by the communications unit 16, and the received telephone call fee payment certificate number is stored in the storage unit 15.

Next, the telephone call fee payment certificate number sales processing operation relating to the first embodiment will be described.

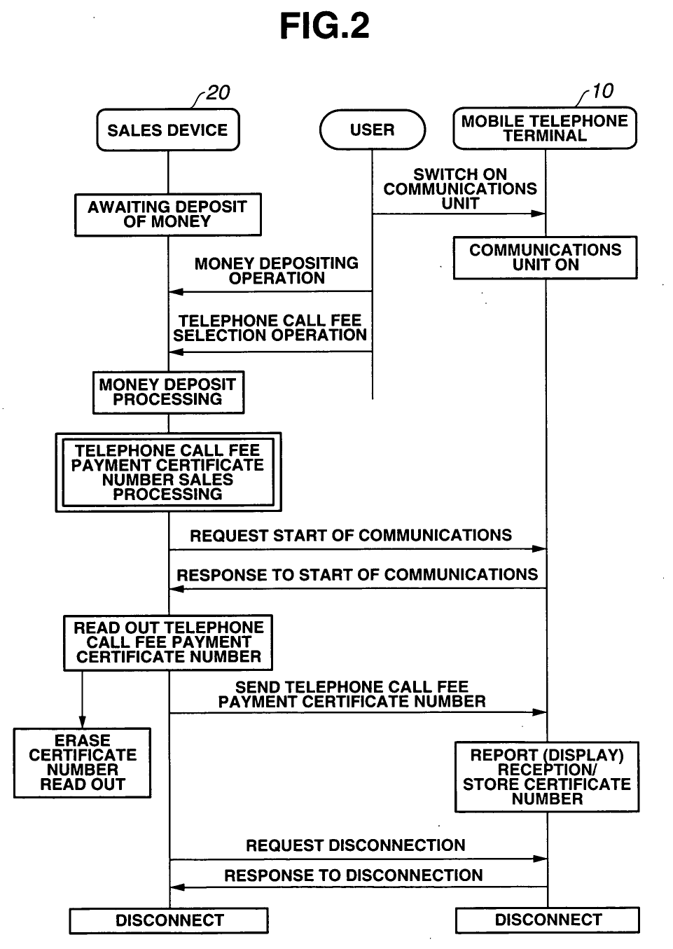

FIG. 2 is a diagram showing the sequence of a telephone call fee payment certificate number sales process in a system according to the first embodiment.

As shown in FIG. 2, when the mobile telephone terminal 10 is to purchase a telephone call fee payment certificate number, firstly, the user performs an operation for switching the communications unit 16 to ON, by means of the operating section 14 of the mobile telephone terminal 10.

By switching the communications unit on in this way, the controller 11 of the mobile telephone terminal 10 sets the communications unit 16 to an ON state.

Next, the user performs an operation (a money depositing operation) in which he or she inserts money sufficient to cover a desired pre-paid telephone call fee, into the currency input slot of the money deposit processing unit 22 of the sales device 20, or inserts a pre-paid type card, or the like, in a card insertion slot of the money deposit processing unit 22, whereupon the user performs an operation of selecting a desired pre-paid telephone call fee (a telephone call fee selection operation).

In this case, the main controller 21 of the sales device 20 causes, for example, the price buttons corresponding to telephone call fees equal to or less than the amount of money that has been deposited into the money deposit processing unit 22 to light up. The user carries out the aforementioned telephone call fee selection operation by pressing the price button corresponding to the desired pre-paid telephone call fee, of the price buttons that are lit up.

When the telephone call fee selection operation has been performed (when the price button has been pressed), the main controller 21 of the sales device 20 carries out processing (money deposit processing) for recognizing information (money deposit information) indicating the amount of money that has been deposited into the money deposit processing unit 22 at the time that the price button is pressed, and it then starts telephone call fee payment certificate number sales processing based on the money deposit information thus processed.

In this telephone call fee payment certificate number sales processing, the main controller 21 of the sales device 20 firstly sends a communications start request from the communications unit 23 to the mobile telephone terminal 10 carried by the user.

Thereupon, the main controller 21 monitors whether or not a communications start response has been received from the mobile telephone terminal 10 by the communications unit 23, and if a communications start response has been received, then it reads out one telephone call fee payment certificate number from the storage unit 24 and sends the telephone call fee payment certificate number thus read out to the mobile telephone terminal 10 by means of the communications unit 23.

Furthermore, in this case, the main controller 21 carries out processing for erasing the telephone call fee payment certificate number sent on this occasion, from the storage unit 24.

When transmission of the aforementioned telephone call fee payment certificate number has been completed, the main controller 21 then sends a disconnection request to the mobile telephone terminal 10 by means of the communications unit 23, whereupon, if a disconnection response is received from the mobile telephone terminal 10 via the communications unit 23, then the main controller 21 disconnects the communication and ends the telephone call fee payment certificate number sales processing sequence.

During the telephone call fee payment certificate number sales process in the sales device 20 described above, the controller 11 of the mobile telephone terminal 10 situated in front of the sales device 20 monitors whether or not a communications start request has been received from the sales device 20 via the communications unit 16, and if a communications start request has been received, then a communications start response is sent to the sales device 20, via the communications unit 16.

Thereupon, when a telephone call fee payment certificate number sent by the sales device 20 is received by the communications unit 16, the controller 11 notifies the user by displaying the fact that a telephone call fee payment certificate number has been received, on the display unit 13, and it also stores the telephone call fee payment certificate number thus received in the storage unit 15.

Thereupon, if a disconnection request sent by the sales device 20 is received by the communications unit 16, then the controller 11 sends a disconnection response to the sales device 20 via the communications unit 16, disconnects the communication, and terminates the processing sequence.

In this way, in the system relating to the first embodiment, a plurality of telephone call fee payment certificate numbers are stored in the sales device 20, and when a money depositing processing for a telephone call fee carried out by the user of a mobile telephone terminal 10 has been accepted, then one of the plurality of stored telephone call fee payment certificate numbers is read out and sent to the mobile telephone terminal 10 carried by the user.

In this case, the telephone call fee payment certificate number sent by the sales device 20 is received by the communications unit 16 of the mobile telephone terminal 10 situated in front of the sales device 20 and it is stored in the storage unit 15.

Here, a telephone call fee payment certificate number is a unique number corresponding to the value of the telephone call fee that has been paid, similarly to a number printed on a card issued when a telephone call fee has been pre-paid in a conventional payment system.

When the unique number (telephone call fee payment certificate number) corresponding to the value of the telephone call fee is registered in a charging center device, in the conventional system, it is necessary to register the number by means of manual operations, but in the case of the mobile telephone terminal 10 according to the present embodiment which stores a telephone call fee payment certificate number corresponding to the unique number in a storage unit 15, the number is registered with the charging center by using a stored information transmitting function whereby the telephone calls up the charging center, establishes a connection and then reads out the telephone call fee payment certificate number from the storage unit 15 and transmits it to the charging center.

Therefore, in the system according to the present embodiment, when the user wishes to register a number with the charging center in order that he or she can use the mobile telephone terminal 10, the user is not required to input manually the unique number certifying payment of the telephone call fee, after paying the telephone call fee, and hence complicated registration operations are eliminated and human errors can be avoided.

Furthermore, since this system sells telephone call fee payment certificate numbers corresponding to payment of telephone call fees, by means of a communications device, the telecommunications operator providing a mobile telephone service based on pre-paid telephone call fees is not required to issue cards and hence the operator can save the costs associated with selling cards.

Moreover, installing a large number of sales devices 20 of this kind which provide good usability for registration operations, over a broad area, can be expected to have the effect of increasing the popularity of mobile telephone terminals based on telephone call fee pre-payment systems.

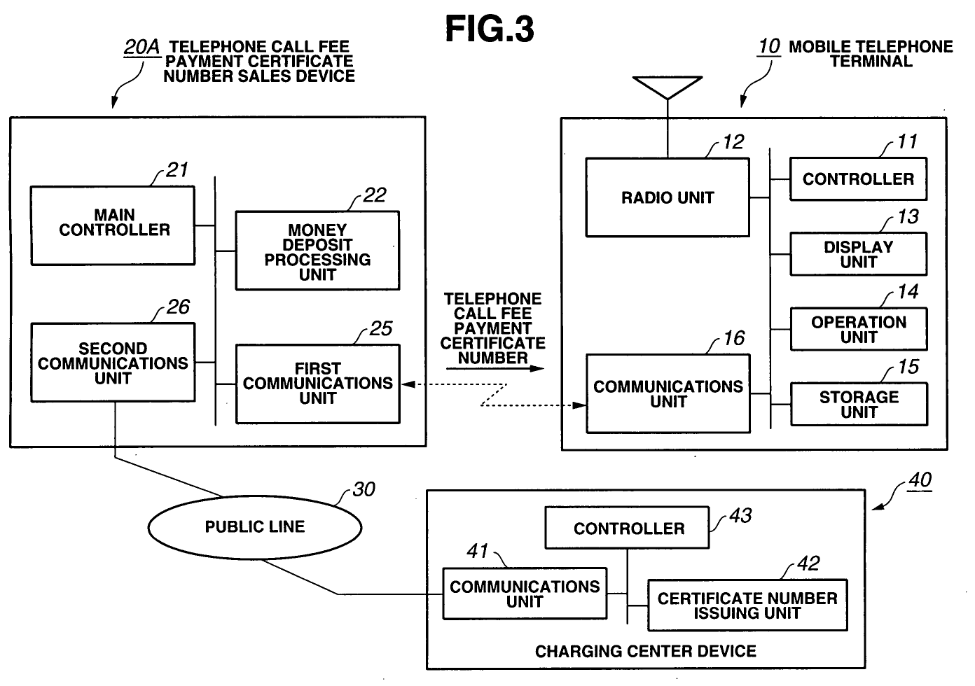

FIG. 3 is a diagram showing the general composition of a telephone call fee payment certificate number sales system relating to a second embodiment of the present invention.

In FIG. 3, the telephone call fee payment certificate number sales system is constituted by a telephone call fee pre-payment type mobile telephone terminal 10 which is carried by a user, and a telephone call fee payment certificate number sales device (hereinafter, abbreviated to “sales device”) 20A, which sells telephone call fee payment certificate numbers (unique numbers) that certify payment of a telephone call fee, when money for a telephone call fee has been received from the user carrying the mobile telephone terminal 10, and a telephone call fee charging center device (hereinafter, abbreviated to “charging center device”) 40, connected to the sales device 20A via a public line 30, which processes payment of telephone call fees, issues a telephone call fee payment certificate number in response to a request from the sales device 20A, and sends the telephone call fee payment certificate number to the sales device 20A.

In the system relating to the second embodiment, the mobile telephone terminal 10 has similar functions to those of the mobile telephone terminal 10 relating to the first embodiment.

Furthermore, the sales device 20A is also similar to the sales device 20 relating to the first embodiment in that it sells a telephone call fee payment certificate number certifying that a telephone call fee corresponding to a particular value has been paid (by sending the telephone call fee payment certificate number to the mobile telephone terminal 10 carried by the user by means of a communications device), when a money depositing process for a telephone call fee required in order to register the mobile telephone terminal 10 so that it is permitted to make calls has been performed by the user carrying the mobile telephone terminal 10 and accepted by the sales device 20A.

However the sales device 20A differs from the sales device 20 relating to the first embodiment in that, after accepting the aforementioned money depositing process, it accesses the charging center device 40 via the public line 30, acquires a telephone call fee payment certificate number issued by the charging center device 40, and sends that telephone call fee payment certificate number to the mobile telephone terminal 10.

Describing this composition is more detail with reference to FIG. 3, the sales device 20A comprises a main controller 21, a money deposit processing unit 22, a first communications unit 25, and a second communications unit 26.

Here, the money deposit processing unit 22 has the same functions and composition as the corresponding portion of the sales device 20 relating to the first embodiment, and the first communications unit 25 has the same functions and composition as the communications unit 23 of the sales device 20 relating to the first embodiment.

Furthermore, the second communications unit 26 communicates with the charging center device 40 via the public line 30, and in particular, it has a communications control function for acquiring a telephone call fee payment certificate number issued by the charging center device 40, from the charging center device 40.

Moreover, the main controller 21 controls the respective sections, such as the money deposit processing unit 22, the first communications unit 25 and the second communications unit 26, and thus controls the sale of telephone call fee payment certificate numbers.

More specifically, for example, if the user deposits money into the money deposit processing unit 22, by means of currency, a pre-paid card, or the like, and then presses a price button corresponding to a desired pre-paid telephone call fee, then money deposit processing is conducted for recognizing that pre-payment has been made for a telephone call fee corresponding to the total of money deposited at that time, and furthermore, the main controller 21 performs control for requesting issue of a telephone call fee payment certificate number from the charging center device 40, by means of the second communications unit 26, when the price button is pressed, receiving a telephone call fee payment certificate number issued by the charging center device 40 in response to this request by means of the second communications unit 26, and sending this telephone call fee payment certificate number to the mobile telephone terminal 10 by means of the first communications unit 25.

Furthermore, the charging center device 40 is a computer installed by the communications operator providing a mobile telephone service based on pre-paid telephone call fees, and it comprises a communications unit 41 having a communications control function for sending and receiving various information between the sales device 20A and the second communications unit 26 (information such as a telephone call fee payment certificate number issue request, a telephone call fee payment certificate number, and the like), in response to the control implemented by the sales device 20A described above, a certification number issuing section 42 for issuing a telephone call fee payment certificate number in response to a request, and a control section 43 for controlling these respective sections.

Next, the telephone call fee payment certificate number sales processing operation relating to the second embodiment will be described.

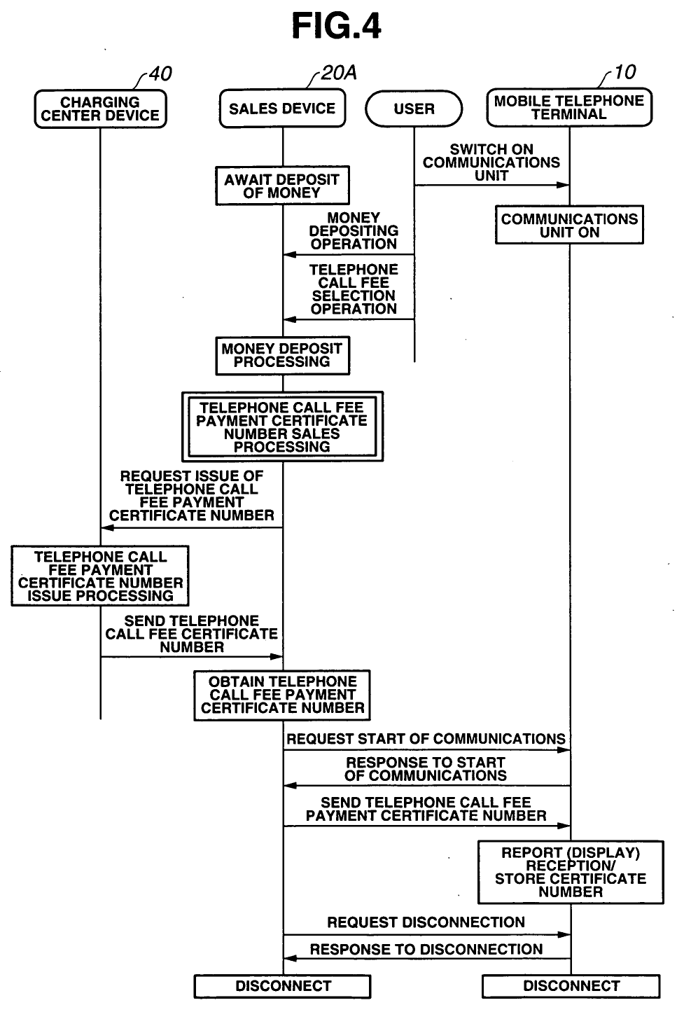

FIG. 4 is a diagram showing the sequence of a telephone call fee payment certificate number sales process in a system according to the second embodiment.

As shown in FIG. 4, when the mobile telephone terminal 10 is to purchase a telephone call fee payment certificate number, firstly, the user performs an operation for switching the communications unit 16 to ON, by means of the operating section 14 of the mobile telephone terminal 10.

By switching the communications unit on in this way, the controller 11 of the mobile telephone terminal 10 sets the communications unit 16 to an ON state.

Next, the user performs an operation (a money depositing operation) in which he or she inserts money sufficient to cover a desired pre-paid telephone call fee, into the currency input slot of the money deposit processing unit 22 of the sales device 20A, or inserts a pre-paid type card, or the like, in a card insertion slot of the money deposit processing unit 22, whereupon the user performs an operation of selecting a desired pre-paid telephone call fee (a telephone call fee selection operation).

In this case, the main controller 21 of the sales device 20A causes, for example, the price buttons corresponding to telephone call fees equal to or less than the amount of money that has been deposited into the money deposit processing unit 22 to light up. The user carries out the aforementioned telephone call fee selection operation by pressing the price button corresponding to the desired pre-paid telephone call fee, of the price buttons that are lit up.

When the telephone call fee selection operation has been performed (when the price button has been pressed), the main controller 21 of the sales device 20A carries out processing (money deposit processing) for recognizing information (money deposit information) indicating the amount of money that has been deposited into the money deposit processing unit 22 at the time that the price button is pressed, and it then starts telephone call fee payment certificate number sales processing based on the money deposit information thus processed.

In this telephone call fee payment certificate number sales process, the main controller 21 of the sales device 20A firstly sends a telephone call fee payment certificate number issue request to the charging center device 40, via the second communications unit 26.

Upon receiving this telephone call fee payment certificate number issue request via the public line 30, the charging center device 40 performs telephone call fee payment certificate number issue processing. This telephone call fee payment certificate number issue processing is described in detail below.

After transmitting a telephone call fee payment certificate number issue request, the main controller 21 of the sales device 20A monitors whether or not a telephone call fee payment certificate number has been received from the charging center device 40 via the second communications unit 26, and if a telephone call fee payment certificate number has been received, then it stores that number provisionally in the storage unit of its internal control unit, for example (acquisition of telephone call fee payment certificate number).

Thereupon, the main controller 21 sends a communications start request to the mobile telephone terminal 10 carried by the user, by means of the first communications unit 25.

Thereupon, the main controller 21 monitors whether or not a communications start response has been received from the mobile telephone terminal 10 by the first communications unit 25, and if a communications start response has been received, then it reads out one telephone call fee payment certificate number stored previously and sends that telephone call fee payment certificate number to the mobile telephone terminal 10 by means of the first communications unit 25.

When transmission of the aforementioned telephone call fee payment certificate number has been completed, the main controller 21 then sends a disconnection request to the mobile telephone terminal 10 by means of the first communications unit 25, whereupon, if a disconnection response is received from the mobile telephone terminal 10 via the first communications unit 25, then the main controller 21 disconnects the communication and ends the telephone call fee payment certificate number sales processing sequence.

During the telephone call fee payment certificate number sales process in the sales device 20A described above, the controller 11 of the mobile telephone terminal 10 situated in front of the sales device 20A monitors whether or not a communications start request has been received from the sales device 20A via the communications unit 16, and if a communications start request has been received, then a communications start response is sent to the sales device 20A, via the communications unit 16.

Thereupon, when a telephone call fee payment certificate number sent by the sales device 20A is received by the communications unit 16, the controller 11 notifies the user by displaying the fact that a telephone call fee payment certificate number has been received, on the display unit 13, and it also stores the telephone call fee payment certificate number thus received in the storage unit 15.

Thereupon, if a disconnection request sent by the sales device 20A is received by the communications unit 16, then the controller 11 sends a disconnection response to the sales device 20A via the communications unit 16, disconnects the communication, and terminates the processing sequence.

Furthermore, in the telephone call fee payment certificate number sales process in the aforementioned sales device 20A, if the charging center device 40 receives the aforementioned telephone call fee payment certificate number issue request sent by the second communications unit 26 of the sales device 20A, by means of the communications unit 41, then the communications unit 43 starts up a certificate number issuing section 42 and issues one telephone call fee payment certificate number (telephone call fee payment certificate number issue process).

Thereupon, the control section 43 sends the telephone call fee payment certificate number issued by the certificate number issuing section 42 to the sales device 20A, via the communications unit 41.

In this way, in the system relating to the second embodiment, when a money depositing process for a telephone call fee performed by the user of a mobile telephone terminal 10 is accepted by the sales device 20A, then the sales device 20A accesses the charging center device 40, acquires a telephone call fee payment certificate number issued by the charging center device 40, and sends that telephone call fee payment certificate number to the mobile telephone terminal 10 carried by the user.

In the composition of the present embodiment, it is also possible for the mobile telephone terminal 10 situated in front of the sales device 20A to receive a telephone call fee payment certificate number sent by the sales device 20A, by means of the communications unit 16, and to store that number in the storage unit 15.

Therefore, similarly to the first embodiment, the user of the mobile telephone terminal 10 is able to register with the charging center device 40, simply by performing an operation for calling the charging center device 40 from the mobile telephone terminal 10, establishing a connection, and then reading out a telephone call fee payment certificate number from the storage unit 15 and transmitting that number. Therefore, the user is not required to input manually a unique number certifying that a telephone call fee has been paid, as in the prior art, and hence complicated registration operations can be eliminated and human errors can be avoided.

Moreover, in the present embodiment also, the telecommunications operator providing a mobile telephone service based on pre-paid telephone call fees does not have to issue cards and hence can save the costs associated with selling cards. Furthermore, by installing a large number of sales devices 20A of this kind which provide good usability for registration operations, over a broad area, the operator can expect to obtain a similar effect to that of the first embodiment, namely, that of increasing the popularity of mobile telephone terminals based on telephone call fee pre-payment systems.

The present invention is not limited to the embodiment described above and illustrated in the drawings, and the invention may be implemented in suitably modified form, provided that the essence of the invention is not changed.

For example, in the embodiments described above, it is a prerequisite that the communications unit 16 of the mobile telephone terminal 10 is in a switched on state when a communications start request is sent from the registration device 20, 20A to the mobile telephone terminal 10, upon completion of the money depositing operation and telephone call fee selection operation by the user at the sales device 20, 20A, but the invention is not limited to this and, for example, an operation for switching on the communications unit 16 of the mobile telephone terminal 10 may be prompted to the user, by displaying guidance advising switching on of the communications unit 16 of the mobile telephone terminal 10, on the display unit (not illustrated) of the sales device 20, 20A, in cases where the communications unit 16 of the mobile telephone terminal 10 is in a switched off state when the aforementioned communications start request is sent.

Moreover, in the respective embodiments described above, the telephone call fee payment certificate number sales device is installed in a solitary fashion, but it is also possible to install the sales device as a combined device incorporated with a drink vending machine, or the like, for example.

### INDUSTRIAL APPLICABILITY

When a money depositing process for a telephone call fee performed by a user of a pre-paid system mobile telephone terminal is accepted by the sales device, a telephone call fee payment certificate number certifying that payment of the telephone call fee has been completed is sent to the mobile telephone terminal of the user. Therefore, this invention is able to provide a telephone call fee payment certificate number sales system and device whereby complicated input operations are not required and hence input errors can be eliminated, when registering a unique number issued in response to payment of a telephone call fee, with a charging center.

1. A telephone call fee payment certificate number sales system comprising: a pre-paid system mobile telephone terminal; and a sales device for selling a telephone call fee payment certificate number certifying that a telephone call fee has been paid, by accepting deposit of money sufficient to cover a telephone call fee to be pre-paid from a user carrying the mobile telephone terminal; wherein
the mobile telephone terminal comprises:
communications means for communicating with the sales device; and
control means for receiving a telephone call fee payment certificate number sent by the sales device via the communications means;
and the sales device comprises:
money deposit processing means for processing the depositing of money for a telephone call fee that is to be pre-paid;
communications means for communicating with the mobile telephone terminal; and
control means for sending the telephone call fee payment certificate number to the mobile telephone terminal via the communications means, when the money deposit processing has been carried out by the money deposit processing means.

2. The telephone call fee payment certificate number sales system according to claim 1, wherein
the sales device comprises:
storage means for storing a plurality of telephone call fee payment certificate numbers; and
the control means successively reads out the telephone call fee payment certificate numbers from the storage means and sends same to the mobile telephone terminal, when the money deposit processing has been carried out.

3. The telephone call fee payment certificate number sales system according to claim 1, wherein
the sales device further comprises:
charging center communications means for communicating with a charging center issuing telephone call fee payment certificate numbers; and
the control means acquires the telephone call fee payment certificate numbers issued by the charging center, via the charging center communications means, and sends same to the mobile telephone terminal.

4. The telephone call fee payment certificate number sales system according to claim 1, wherein the communications means of the mobile telephone terminal and the communications means of the sales device are infrared communications means performing communications by means of infrared.

5. The telephone call fee payment certificate number sales system according to claim 1, wherein the communications means of the mobile telephone terminal and the communications means of the sales device are short-distance wireless communications means performing communications based on a short-distance wireless communications system.

6. The telephone call fee payment certificate number sales system according to claim 1, wherein the communications means of the mobile telephone terminal and the communications means of the sales device are wired communications means performing communications based on a wired communications system.

7. A telephone call fee payment certificate number sales device for accepting deposit of money sufficient to cover a telephone call fee to be pre-paid from a user carrying a pre-paid system mobile telephone terminal and for selling a telephone call fee payment certificate number certifying that a telephone call fee has been paid; comprising:
money deposit processing means for processing the depositing of money for a telephone call fee that is to be pre-paid;
communications means for communicating with the mobile telephone terminal; and
control means for sending the telephone call fee payment certificate number to the mobile telephone terminal via the communications means, when the money deposit processing has been carried out by the money deposit processing means.

8. The telephone call fee payment certificate number sales device according to claim 7, comprising: storage means for storing a plurality of telephone call fee payment certificate numbers; wherein
the control means successively reads out the telephone call fee payment certificate numbers from the storage means and sends same to the mobile telephone terminal, when the money deposit processing has been carried out.

9. The telephone call fee payment certificate number sales device according to claim 7, further comprising: charging center communications means for communicating with a charging center issuing telephone call fee payment certificate numbers; wherein
the control means acquires the telephone call fee payment certificate numbers issued by the charging center, via the charging center communications means, and sends same to the mobile telephone terminal.

10. The telephone call fee payment certificate number sales device according to claim 7, wherein the communications means is infrared communications means for performing communications by means of infrared.

11. The telephone call fee payment certificate number sales device according to claim 7, wherein the communications means is short-distance wireless communications means for performing communications based on a short-distance wireless communications system.

12. The telephone call fee payment certificate number sales device according to claim 7, wherein the communications means is wired communications means for performing communications based on a wired communications system.
